(19) United States
(12) Patent Application Publication
(10) Pub. No.: US 2002/0054631 A1
(43) Pub. Date: May 9, 2002

(54) Modem and method for adjusting data transmission speed of the same

(75) Inventor: Jung-Ho Kim, Kyungki-do (KR)

Correspondence Address: SUGHRUE, MION, ZINN, MACPEAK & SEAS, PLLC, 2100 Pennsylvania Avenue, NW, Washington, DC, 20037-3213, US

(73) Assignee: SAMSUNG ELECTRONICS CO., LTD.

(21) Appl. No.: 09/922,923

(22) Filed: Aug. 7, 2001

(30) Foreign Application Priority Data
Aug. 7, 2000 (KR) 2000-45739

(51) Int. Cl. H04L 23/00; H04L 5/16; H04B 1/38

(52) U.S. Cl. 375/222; 375/377

(57) ABSTRACT

A modem and method for adjusting data transmission speed of the modem is provided. The modem, installed between a subscriber's terminal and an external modem for relaying communication, includes a timer for determining data transmission speed from the external modem, and a timer controller for performing a training process for determining data transmission speed of a line connecting the modem and the external modem. The timer controller determining a clock value of the timer based on the data transmission speed of the line determined by the training process. Accordingly, the data transmission speed of the model can be adjusted according to the data transmission speed of the line.

### RELATED APPLICATION

The present Application claims priority from Korean Patent Application No 2000-45739, the contents of which are incorporated herein by reference.

### BACKGROUND OF THE INVENTION

1. Field of the Invention

The present invention relates to a modem, and more particularly a modem and method for adjusting data transmission speed of the same.

2. Description of the Related Art

ADSL (Asymmetric Digital Subscriber Line) performs general telephoning and high speed data communications through an existing telephone line.

FIG. 1 is a block diagram showing a connection status of the ADSL modem with a main station where the ADSL modem is installed.

The ADSL modem (ATU-R) 12, installed at a home 10 of a subscriber who wishes to access the Internet 30 or VOD through the ADSL, is connected to the ADSL modem (DSLAM, ATU-C) 22 installed at the main station (ADSL operational center) 20 through an ADSL leased-line.

The ATU-R 12 is connected to a computer 14 and a telephone 16 through a splitter 18.

The ADSL has a downstream speed from the main station to the subscriber's terminal, which differs from an upstream speed from the subscriber's terminal to the main station. Thus, data transmission of the ADSL is asymmetrical in which a host terminal of the subscriber is connected to and receives broadband information such as images from the Internet 30 using high speed while sending signal using low speed. Generally, the upstream speed is 1 Mbps and the downstream speed is up to 8 Mbps.

Since the transmission speed is affected by the status of the line, including factors such as the length of the telephone line, the diameter of the telephone line, the presence of a bridge tap, the strength of an interface and the decrease of the signal, the amount of bits per carrier transmitted through the leased-line is determined during the training period, wherein a test signal is transmitted from the main station to a modem of the subscriber when the subscriber attempts connection.

In other words, the transmission speed between the lines is determined as the subscriber's modem receives the test signal, and sends a signal that determines an optimal bit allocation, to the ADSL modem 22 based on a signal-to-noise ratio (R/N).

When data is sent from ADSL modem to a telephone line, clock speed generated from a timer installed in the modem is most likely to be used.

If there is a predetermined clock speed of the timer, for synchronizing the respective control actions, the predetermined clock speed often does not match with the speed of the line set during the training term.

In other words, if the predetermined clock speed of the timer is lower than the speed of the line set during the training term, the line cannot be used effectively, since the data is sent without being recorded in the clock.

If the predetermined clock speed is higher than the speed of the line set during the training term, the data will over flow and thus be discarded.

### SUMMARY OF THE INVENTION

The present invention has been made to overcome the above-mentioned problems of the related art. Accordingly, it is an object of the present invention to provide a modem and a method for adjusting data transmission speed, to prevent data overflow, by determining the transmission speed according to the speed determined through a training process when a channel is newly set between a subscriber's modem and a modem of a main station.

The above object is accomplished by a modem installed between a subscriber's terminal and an external modem for relaying communication according to the present invention, including a timer for determining data transmission speed from the external modem, and a timer controller for performing a training process for determining data transmission speed of a line connecting the modem and the external modem. The timer controller determines a clock value of the timer based on the data transmission speed of the line determined by the training process.

The above object is also accomplished by a method for adjusting data transmission speed of a modem installed between a subscriber's terminal and an external modem for relaying communication therebetween according to the present invention, including the steps of: performing a training process with an external modem for determining data transmission speed for transmitting data to the external modem when the modem attempts a connection to the external modem, setting a clock setting value of a timer for synchronizing the data transmission speed to the external modem corresponding to the data transmission speed determined by the training process, and sending and receiving data with the external modem during the connection to the external modem according to the clock setting value of the timer.

### BRIEF DESCRIPTION OF THE DRAWINGS

Reference may now be made to the accompanying drawings for a better understanding of the present invention, wherein

FIG. 1 is a diagram showing a status of connection between a main station and an ADSL modem;

FIG. 2 is a block diagram of a modem (ATU-R) installed at a subscriber's terminal;

FIG. 3 is a detailed block diagram of a transmission speed determining part;

FIG. 4 is a view of a code being stored in a flash memory; and

FIG. 5 is a flow chart for explaining a method for adjusting data transmission speed of the modem according to the present invention.

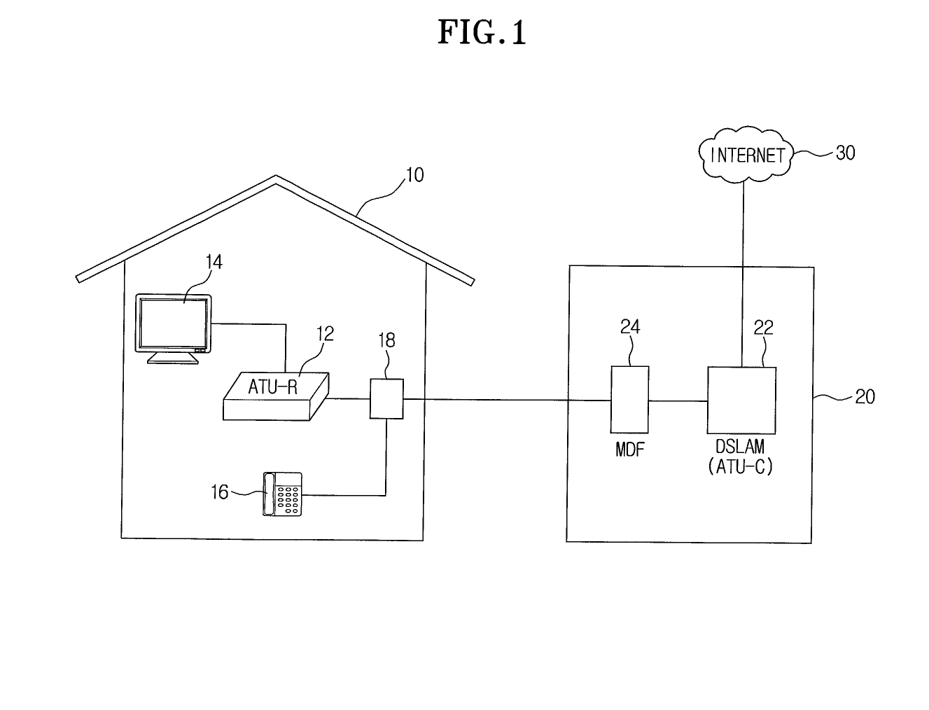

### DETAILED DESCRIPTION OF PREFERRED EMBODIMENT

Detailed description according to the preferred embodiment of the present invention will be followed referring to the attached drawings.

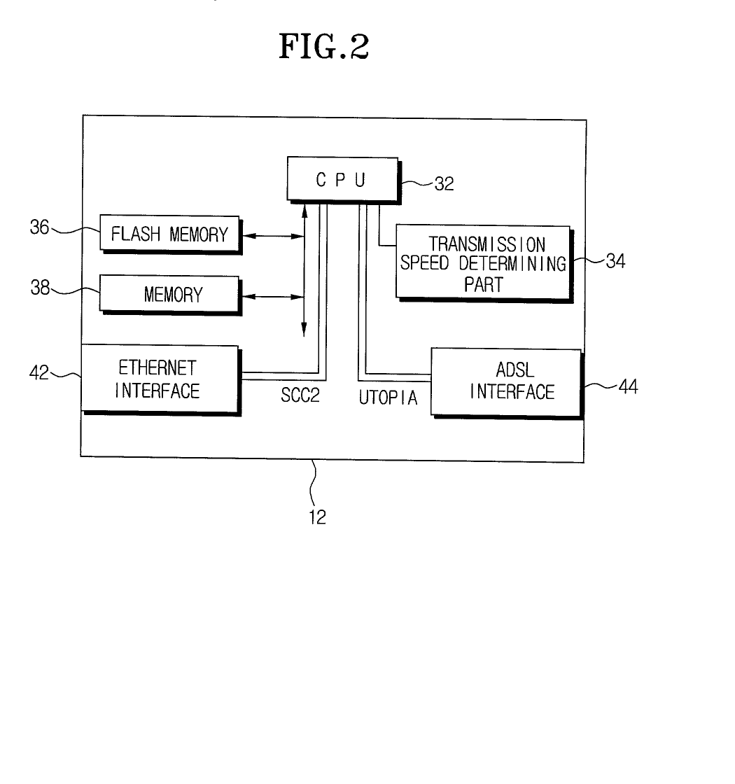

FIG. 2 is a block diagram of a modem installed at a subscriber's home.

CPU 32 of ATU-R is connected to Ethernet interface 42 via SCC2 bus, and to ADSL interface 44 via UTOPIA bus. The ATU-R performs SAR (Segmentation and Reassembly) function.

As shown in FIG. 4, there exists a flash memory 36 for storing a boot code, an application code and a profile. A general memory 38 for storing information associated with the CPU 32 is further provided as illustrated in FIG. 2.

Also, a transmission speed determining part 34 for determining data transmission speed of the modem is built in ATU-R 12.

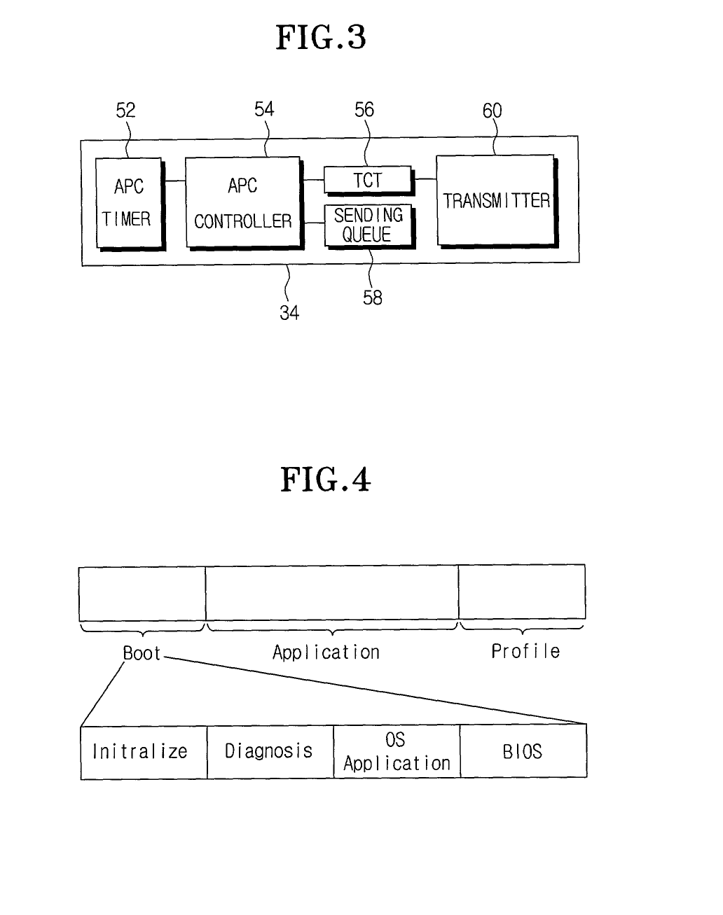

FIG. 3 is a detailed block diagram of the transmission speed determining part 34.

The transmission speed determining part 34 comprises an APC timer 52, an APC timer controller 54, a TCT 56, a sending queue 58, and a transmitter 60.

Generally, in a modem that transmits data with ATM (Asynchronous Transfer Mode), a multiplication is carried out, i.e., a number of logical communication channels (virtual channels) are created on a transmission line so that multiple information can be transmitted simultaneously via the transmission line.

Meanwhile, the APC timer 52 generates a clock in a regulated cycle. The cycle is called a time slot, and the communication channel is determined according to the time slot.

For example, if the number of the communication channels established by the multiplication exceeds the number (N) of the channels that can be transmitted during the time slot, then N channels are selected during the first time slot and the rest of the channels are controlled to be sent for the next time slot.

Thus, the cycle generated by the APC timer 52 determines the number of the communication channels and thereby determines the transmission speed (bps) of the modem.

TCT (Transmit Connection Table) 56 stores cycle parameters for the respective communication channels.

The sending queue 58 is a FIFO wherein a transmission channel number is recorded.

The transmitter 60 transmits the communication channels according to the transmission channel numbers recorded in the sending queue 58.

However, the value of the conventional APC timer was determined appropriately at the time of initialization, regardless of the line establishment.

According to the present invention, however, the transmission speed of the line is determined by a training process between the subscriber's modem and each of the ADSL modem of the main station, and recorded in the APC timer controller 54.

Accordingly, the APC timer controller 54 controls the value of the APC timer 52 by calculating the setting value of the timer corresponding to the transmission speed of the line determined by the training process.

Then, the APC timer controller 54 adjusts the speed of the modem by varying the clock of the APC timer 52.

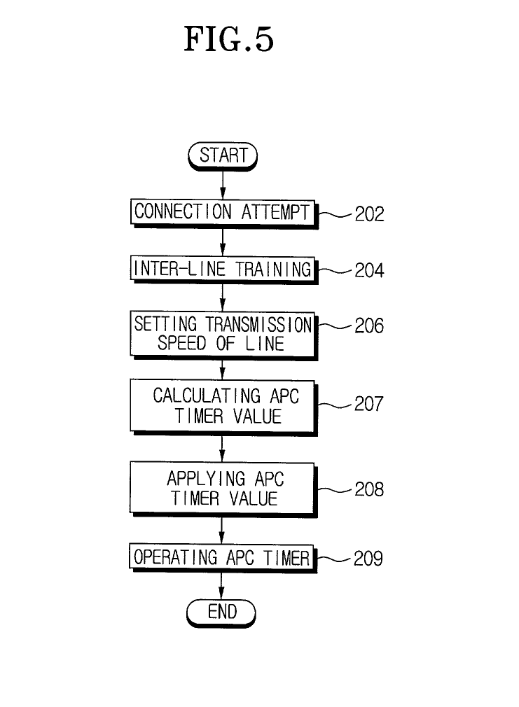

FIG. 5 is a flow chart illustrating a method for adjusting data transmission speed of the modem according to the present invention.

If the power of the subscriber's ADSL modem (ATU-R) is on, the modem performs an initialization process and self-examination.

If the modem attempts to connect to ATU-C of the main station (step S202), the training process is carried out, i.e., a test signal is transmitted to the subscriber's modem to determine the transmission speed between the lines (step S204).

The transmission speed of the lines could differ from one another by nature of ADSL. Additionally, transmission speed varies for respective lines according to the character of the line or the length of the line. Thus, the transmission speed of the line is set by the training process between the subscriber's modem and each of the modem of the main station (step S206).

The clock setting value of the APC timer 52 is calculated based on the value set, which is subjected to the training process (step S207). Next the calculated clock setting value of the APC timer 52 is applied to the APC timer 52 (step S208). Then the APC timer 52 transmits data by generating a clock according to the clock setting value (step S209).

Whenever the modem is disconnected and then reconnected by the training process, the value of the APC timer 52 is updated according to the set transmission speed of the line.

As described so far, according to the modem and the method for adjusting data transmission speed according to the present invention, the data transmission speed of the set modem could be used very effectively by determining the value of the APC timer 52 according to the speed of the line determined after finishing the training process between the subscriber's modem and the modem of the main station.

The transmission speed is always controlled according to the transmission speed of the line. Therefore, the possibility of data overflow in the sending queue or the ineffective use of the line can be greatly reduced.

It will be understood by those skilled in the art that the present invention should not be limited to the described preferred invention, but various changes and modifications can be made within the spirit and scope of the present invention. Accordingly, the scope of the present invention is not limited within the described range but the following claims.

What is claimed is:

1. A modem installed between a subscriber's terminal and an external modem for relaying communication, the modem comprising:
a timer for determining data transmission speed from the external modem; and
a timer controller for performing a training process for determining data transmission speed of a line connecting the modem and the external modem, the timer controller determining a clock value for the timer based on the data transmission speed of the line determined by the training process.

2. The modem of claim 1, wherein the timer controller determines the clock value of the timer whenever the modem attempts a connection to the external modem.

3. The modem of claim 1, wherein the line is a telephone line and the modem is Asymmetrical Digital Subscriber Line (“ADSL”).

4. The modem of claim 1, wherein the external modem is installed at a main station that performs Asymmetrical Digital Subscriber Line (“ADSL”) service to a plurality of subscribers' terminals.

5. A method for adjusting data transmission speed of a modem in a subscriber's terminal and an external modem for relaying communication therebetween, the method comprising the steps of:
performing a training process with the external modem for determining data transmission speed for transmitting data to the external modem when the modem attempts a connection to the external modem;
setting a clock setting value of a timer for synchronizing the data transmission speed to the external modem corresponding to the data transmission speed determined by the training process; and
sending and receiving data with the external modem during the connection to the external modem according to the clock setting value of the timer.

6. The method for adjusting transmission speed of a modem of claim 5, wherein the clock setting value of the timer is adjusted whenever connection is established between the modem and the external modem.

7. The method for adjusting transmission speed of a modem of claim 5, wherein the modem and the external modem is connected through a telephone line and the modem is an Asymmetrical Digital Subscriber Line (“ADSL”) modem.

8. The method for adjusting transmission speed of a modem of claim 5, wherein the external modem is installed at a central office performing Asymmetrical Digital Subscriber Line (“ADSL”) service to a plurality of subscribers' terminals.
